(19) United States
(12) Patent Application Publication
(10) Pub. No.: US 2020/0211074 A1
(43) Pub. Date: Jul. 2, 2020

(54) ROSTER-BASED ENTITY SELECTION MACHINE

(71) Applicant: FloatThat Corporation, San Jose, CA (US)

(72) Inventor: Ali Rizvi, San Jose, CA (US)

(21) Appl. No.: 15/760,642

(22) PCT Filed: Mar. 15, 2018
(86) PCT No.: PCT/US2018/022563

§ 371 Date: Mar. 16, 2018

Related U.S. Application Data
(60) Provisional application No. 62/472,105, filed on Mar. 16, 2017.

(51) Int. Cl. G06Q 30/06; G06F 16/23; G06Q 30/00

(52) U.S. Cl. CPC G06Q 30/0605; G08B 23/00; G06Q 30/018; G06F 16/2379

(57) ABSTRACT

A selection machine is configured to access a roster size scalar assigned to an item by a provider. The roster size scalar quantifies entities to be represented in a roster data structure for the item. The machine generates the roster data structure, which includes entity fields that are quantified by the roster size scalar and specify no entities. For each entity field, the machine detects that an entity is qualified for representation in the roster data structure, and the machine accordingly modifies the roster data structure by causing the entity field to correspond to the entity and specify the entity. In response to a final entity field specifying a corresponding entity, the machine selects an entity field to specify a selected entity for assignment to the item. The machine causes of a device of the provider to present a notification that the item is assigned to the selected entity.

### RELATED APPLICATION

This application claims the priority benefit of U.S. Provisional Patent Application No. 62/472,105, entitled “METHODS AND PLATFORM FOR BUYING AND SELLING” and filed Mar. 16, 2017, which is incorporated herein by reference in its entirety.

### TECHNICAL FIELD

The subject matter disclosed herein generally relates to the technical field of special-purpose machines that facilitate decision-making and initiation of actions based on that decision-making, including software-configured computerized variants of such special-purpose machines and improvements to such variants, and to the technologies by which such special-purpose machines become improved compared to other special-purpose machines that facilitate decision-making and initiation of actions based on that decision-making. Specifically, the present disclosure addresses systems and methods to facilitate roster-based entity selection by a machine.

### BACKGROUND

A machine may be specially configured to automatically make a decision and initiate performance of one or more actions in response to the decision made. For example, a machine may be specially configured to calculate a time at which a rubber curing mold should be opened and then to open the mold at the calculated time. In some situations, such a decision-making machine is specially configured to interact with one or more users by causing one or more corresponding devices to present (e.g., within a graphical user interface) a notification that indicates the decision made, to perform one or more operations based on the decision, or both.

### BRIEF DESCRIPTION OF THE DRAWINGS

Some embodiments are illustrated by way of example and not limitation in the figures of the accompanying drawings.

FIG. 1 is a network diagram illustrating a network environment suitable for roster-based selection of an entity, according to some example embodiments.

FIG. 2 is a block diagram illustrating components of a selection machine suitable for performing roster-based selection of an entity, according to some example embodiments.

FIG. 3 is a block diagram illustrating a roster data structure suitable for roster-based selection of an entity, according to some example embodiments.

FIGS. 4-7 are flowcharts illustrating operations of the selection machine in performing a method of roster-based entity selection, according to some example embodiments.

FIGS. 8 and 9 are flowcharts illustrating example user experiences potentially provided or otherwise facilitated by the selection machine in performing the method of roster-based entity selection, according to some example embodiments.

FIG. 10 is a diagram illustrating example screenshots of a graphical user interface during and after roster-based entity selection, according to some example embodiments.

FIG. 11 is a block diagram illustrating components of a machine, according to some example embodiments, able to read instructions from a machine-readable medium and perform any one or more of the methodologies discussed herein.

### DETAILED DESCRIPTION

Example methods (e.g., algorithms) facilitate automated roster-based selection of one or more entities represented in a roster data structure, and example systems (e.g., special-purpose machines configured by special-purpose software) are configured to facilitate automated roster-based selection of one or more entities that are represented in a roster data structure. The selection of an entity is based on the roster data structure and is therefore referred to herein as a roster-based selection of the entity. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

A roster-based selection machine is specially configured to access a roster size scalar, which may be assigned to an item by a provider. As used herein, an “item” may be or include a physical good (e.g., a jacket or a car), a digital good (e.g., a movie or a song), a service (e.g., dental care, medical care, or car repair), an authorization (e.g., concert tickets or a software license), an amount of a medium of exchange (e.g., money, credits, tokens, points, and the like), or any suitable combination thereof. For example, the roster size scalar may be accessed from a database or received from a device of the provider. The roster size scalar is a scalar value that defines the size of the roster data structure to be generated for that item and quantifies entities (e.g., users, participants, contributors, interested parties, or any suitable combination thereof) that will be represented (e.g., by being listed or otherwise specified) in the roster data structure to be generated for that item.

The roster-based selection machine then generates the roster data structure, which is a specialized and innovative data structure, and the generated roster data structure includes entity fields that are quantified by the roster size scalar and that specify no entities. For example, the entity fields may initially include default content (e.g., null values, zero values, or space characters) that specify no entities as being represented in the entity fields of the roster data structure, and each entity field may later be modified to both correspond to an entity (e.g., an entity that has become qualified for representation in the roster data structure for the item) and specify that corresponding entity. The entity fields may be created as a sequence of ordered (e.g., enumerated) entity fields or as a set of unordered (e.g., non-enumerated) entity fields. In either case, the generated roster data structure includes a final entity field that additionally functions as an indicator (e.g., flag, marker, or other indicative metadata) that the entire roster data structure is ready for entity selection.

Accordingly, for each entity field among the entity fields in the roster data structure, the roster-based selection machine detects that an entity is qualified for representation in the roster data structure that corresponds to the item. Accordingly, the roster-based selection machine modifies the roster data structure (e.g., within a memory or within a database) by causing that entity field to correspond to the qualified entity and specify the qualified entity.

When the final entity field is modified to contain non-default content, the roster data structure is ready for entity selection, and the presence of non-default content in the final entity field indicates such readiness. Accordingly, in response to the final entity field specifying its corresponding qualified entity, the roster-based selection machine selects an entity field from the roster data structure, and the corresponding entity specified by the selected entity field becomes a selected entity for assignment to the item. This may be performed by designating a selected entity field among the entity fields in the roster data structure, such that the selected entity field specifies its corresponding selected entity to be assigned to the item. The roster-based selection machine then causes a device of the provider of the item to present a notification that the item is assigned to the selected entity. Further details are discussed below.

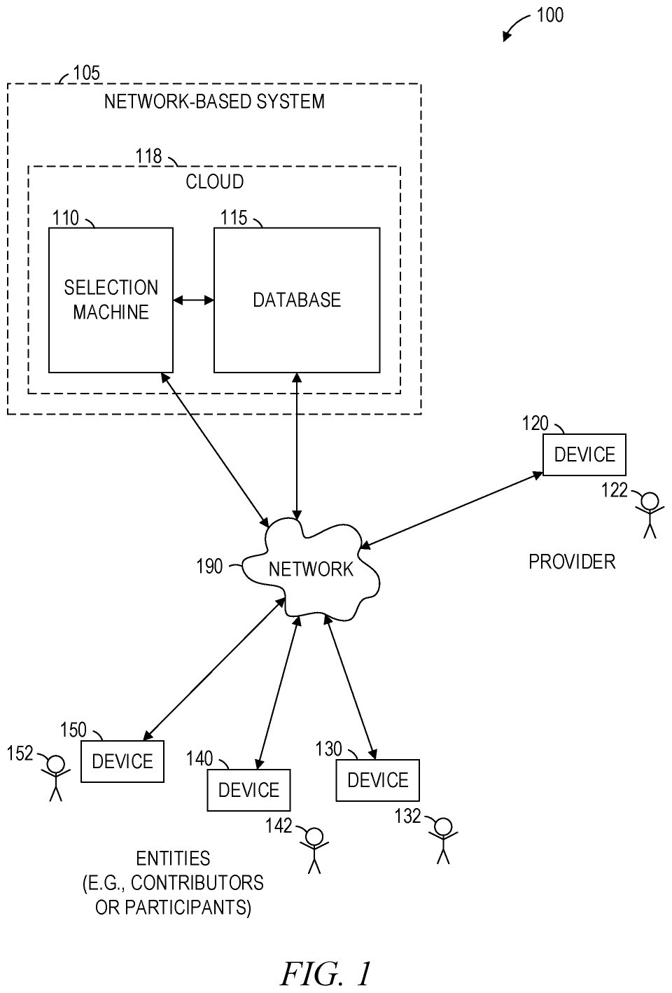

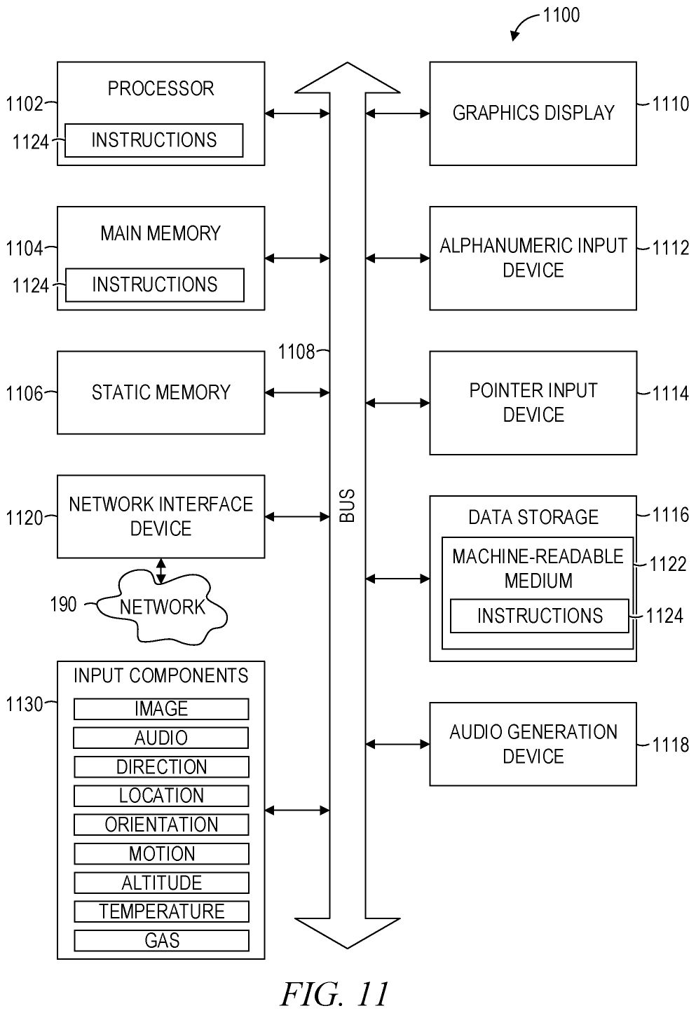

FIG. 1 is a network diagram illustrating a network environment 100 suitable for roster-based selection of an entity, according to some example embodiments. The network environment 100 includes a selection machine 110, a database 115, and devices 120, 130, 140, and 150, all communicatively coupled to each other via a network 190. The selection machine 110, with or without the database 115, may form all or part of a cloud 118 (e.g., a geographically distributed set of multiple machines configured to function as a single server), which may form all or part of a network-based system 105 (e.g., a cloud-based server system configured to provide one or more network-based services to one or more of the devices 120, 130, 140, and 150). The selection machine 110, the database 115, and the devices 120, 130, 140, and 150 may each be implemented in a special-purpose (e.g., specialized) computer system, in whole or in part, as described below with respect to FIG. 11.

Also shown in FIG. 1 are users 122, 132, 142, and 152. One or more of the users 122, 132, 142, and 152 may be a human user (e.g., a human being), a machine user (e.g., a computer configured by a software program to interact with the device 120, 130, 140, or 150), or any suitable combination thereof (e.g., a human assisted by a machine or a machine supervised by a human). The user 122 is associated with the device 120 and may be a user of the device 120. For example, the device 120 may be a desktop computer, a vehicle computer, a tablet computer, a navigational device, a portable media device, a smart phone, or a wearable device (e.g., a smart watch, smart glasses, smart clothing, or smart jewelry) belonging to the user 122. For brevity and clarity, the example scenarios discussed herein describe the user 122 as a provider of an item, though this need not be the case.

The user 132 is associated with the device 130 and may be a user of the device 130. For example, the device 130 may be a desktop computer, a vehicle computer, a tablet computer, a navigational device, a portable media device, a smart phone, or a wearable device (e.g., a smart watch, smart glasses, smart clothing, or smart jewelry) belonging to the user 132. Similarly, the user 142 is associated with the device 140 and may be a user of the device 140. For example, the device 140 may be a desktop computer, a vehicle computer, a tablet computer, a navigational device, a portable media device, a smart phone, or a wearable device (e.g., a smart watch, smart glasses, smart clothing, or smart jewelry) belonging to the user 142. Likewise, the user 152 is associated with the device 150 and may be a user of the device 150. As an example, the device 150 may be a desktop computer, a vehicle computer, a tablet computer, a navigational device, a portable media device, a smart phone, or a wearable device (e.g., a smart watch, smart glasses, smart clothing, or smart jewelry) belonging to the user 152. For brevity and clarity, the example scenarios discussed herein describe the users 132, 142, and 152 as examples of entities, and other examples of such entities may be or include persons or organizations (e.g., companies, families, or other groups) interested in being represented in a roster data structure for an item (e.g., as contributors or as other participants).

Any of the systems or machines (e.g., databases and devices) shown in FIG. 1 may be, include, or otherwise be implemented in a special-purpose (e.g., specialized or otherwise non-conventional and non-generic) computer that has been specially modified to perform one or more of the functions described herein for that system or machine (e.g., configured or programmed by special-purpose software, such as one or more software modules of a special-purpose application, operating system, firmware, middleware, or other software program). For example, a special-purpose computer system able to implement any one or more of the methodologies described herein is discussed below with respect to FIG. 11, and such a special-purpose computer may accordingly be a means for performing any one or more of the methodologies discussed herein. Within the technical field of such special-purpose computers, a special-purpose computer that has been specially modified (e.g., configured by special-purpose software) by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the systems or machines illustrated in FIG. 1 may be combined into a single system or machine, and the functions described herein for any single system or machine may be subdivided among multiple systems or machines.

The network 190 may be any network that enables communication between or among systems, machines, databases, and devices (e.g., among the machine 110 and any one or more of the devices 120, 130, 140, and 150). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone service (POTS) network), a wireless data network (e.g., a WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

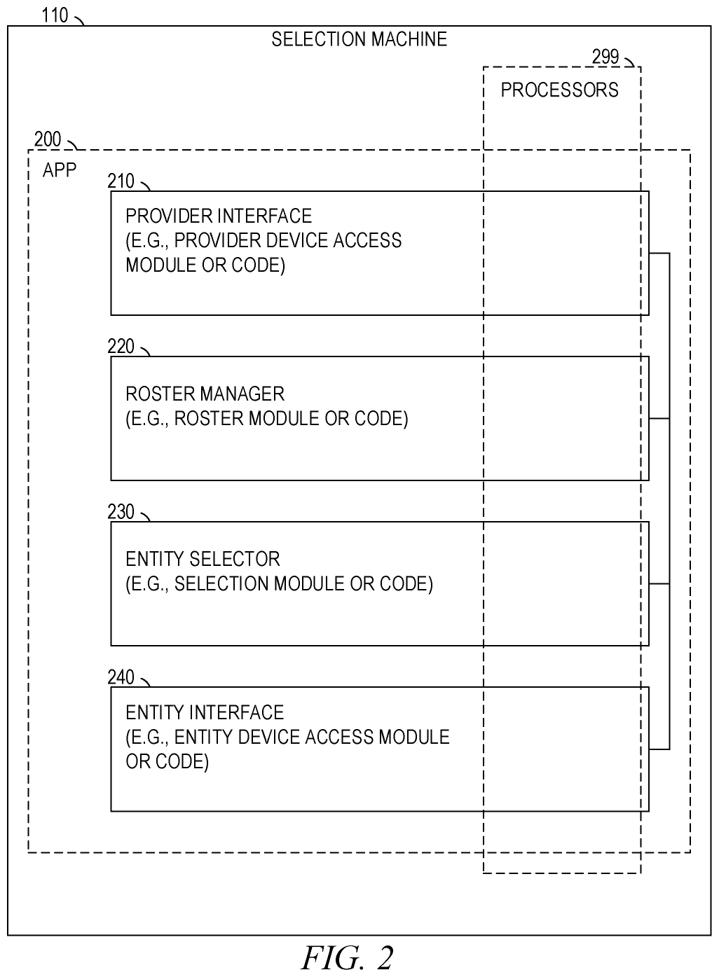

FIG. 2 is a block diagram illustrating components of the selection machine 110, according to some example embodiments. The selection machine 110 is shown as including a provider interface 210, roster manager 220, an entity selector 230, and an entity interface 240, all configured to communicate with each other (e.g., via a bus, shared memory, or a switch).

The provider interface 210 may be or include a provider device access module (e.g., configured to interface or otherwise interact with the device 120 of the user 122, who may be a provider of an item) or similarly suitable software code. The roster manager 220 may be or include a roster module (e.g., configured to generate and modify one or more roster data structures) or similarly suitable software code. The entity selector 230 may be or include a selection module (e.g., configured to designate one or more entities as being selected, for example, by designating one or more entity identifiers that identify or otherwise correspond to the selected entities) or similarly suitable software code. The entity interface 240 may be or include an entity device access module (e.g., configured to interface or otherwise interact with one or more of the devices 130, 140, and 150, which may belong to the entities, such as the users 132, 142, and 152, respectively) or similarly suitable software code.

As shown in FIG. 2, the provider interface 210, the roster manager 220, the entity selector 230, the entity interface 240, or any suitable combination thereof, may form all or part of an app 200 (e.g., a server app or a mobile app) that is stored (e.g., installed) on the selection machine 110 (e.g., responsive to or otherwise as a result of data being received via the network 190). Furthermore, one or more processors 299 (e.g., hardware processors, digital processors, or any suitable combination thereof) may be included (e.g., temporarily or permanently) in the app 200, the provider interface 210, the roster manager 220, the entity selector 230, the entity interface 240, or any suitable combination thereof.

Any one or more of the components (e.g., modules) described herein may be implemented using hardware alone (e.g., one or more of the processors 299) or a combination of hardware and software. For example, any component described herein may physically include an arrangement of one or more of the processors 299 (e.g., a subset of or among the processors 299) configured to perform the operations described herein for that component. As another example, any component described herein may include software, hardware, or both, that configure an arrangement of one or more of the processors 299 to perform the operations described herein for that component. Accordingly, different components described herein may include and configure different arrangements of the processors 299 at different points in time or a single arrangement of the processors 299 at different points in time. Each component (e.g., module) described herein is an example of a means for performing the operations described herein for that component. Moreover, any two or more components described herein may be combined into a single component, and the functions described herein for a single component may be subdivided among multiple components. Furthermore, according to various example embodiments, components described herein as being implemented within a single system or machine (e.g., a single device) may be distributed across multiple systems or machines (e.g., multiple devices).

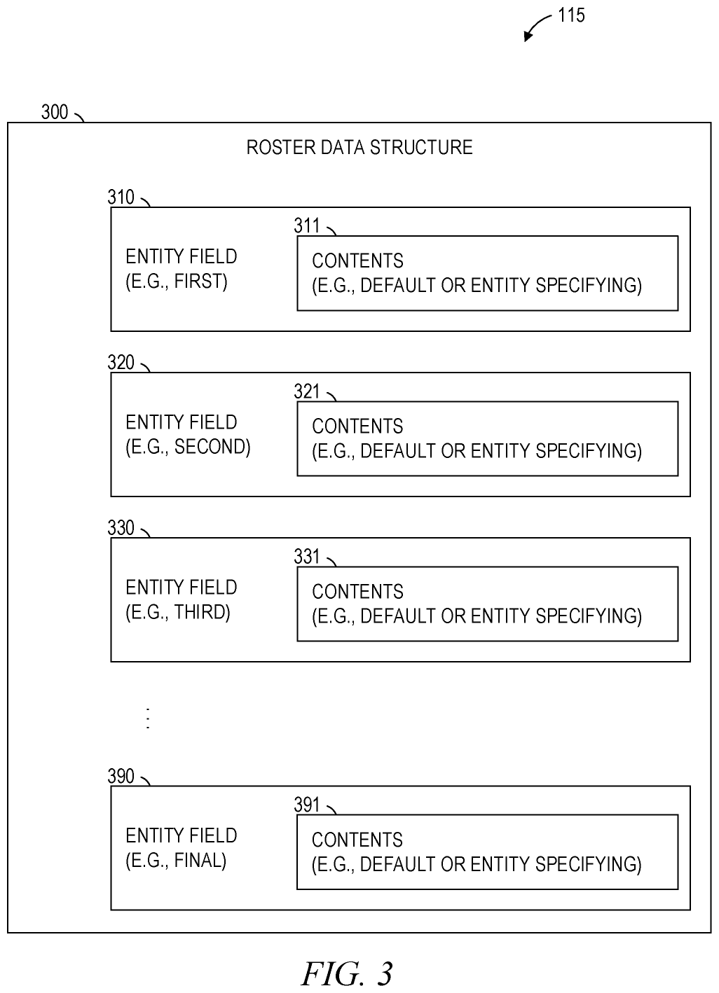

FIG. 3 is a block diagram illustrating a roster data structure 300 suitable for roster-based selection of an entity, according to some example embodiments. The roster data structure 300 may be generated by the roster manager 220 in the selection machine 110 and stored thereafter by the selection machine 110, the database 115, or another suitable data repository. As shown in FIG. 3, the roster data structure 300 includes multiple entity fields 310, 320, 330, and 390.

The number of entity fields (e.g., entity fields 310, 320, 330, and 390) may be determined by a number called a roster size scalar, which may have been assigned to an item. In FIG. 3, the illustrated entity fields 310, 320, 330, and 390 in the example embodiments shown are four (4) in number, and the roster size scalar in these example embodiments would be four (4). The entity fields 310, 320, 330, and 390 are thus collectively quantified by the roster size scalar. When the roster data structure 300 is freshly generated, the entity fields 310, 320, 330, and 390 all specify no entities. For example, the entity fields may initially include default content (e.g., null values, zero values, or space characters) that make no references to any entities. Later, each entity field may later be separately modified to both correspond to an entity (e.g., an entity, such as the user 132, that has become qualified for representation in the roster data structure 300) and specify that corresponding entity (e.g., by storing an identifier of that entity). As noted above, the entity fields 310, 320, 330, and 390 may be created as a sequence of ordered entity fields (e.g., a first entity field, second entity field, third entity field, . . . and a final entity field) or as a set of unordered entity fields (e.g., non-enumerated entity fields that are independently modified one by one until the last entity field is modified).

As shown in FIG. 3, the roster data structure 300 is a specialized data structure in which the entity field 390 is a final entity field that additionally functions as an indicator (e.g., flag, marker, or other indicative metadata) that the entire roster data structure 300 is ready for entity selection. That is, entity selection may be triggered by or otherwise performed in response to the modification of the final entity field (e.g., entity field 390) from its default content (e.g., default value) to entity specifying content that specifies a corresponding entity (e.g., the user 152).

Accordingly, when the roster data structure 300 is completely modified to the point where each of the entity fields 310, 320, 330, and 390 corresponds to a respective entity and specifies that respectively corresponding entity, the entity selector 230 in the selection machine 110 may designate one of the entity fields 310, 320, 330, and 390 as a selected entity field. This may have the effect of selecting the corresponding entity for assignment to the item. That is, the designation of one of the entity fields 310, 320, 330, and 390 in response to the final entity field 390 becoming modified to specify its corresponding entity may cause the entity selector 230 to automatically choose one of the entity fields 310, 320, 330, and 390 for assignment of its corresponding entity (e.g., user 152) to the item for which the roster data structure 300 was generated. In some example embodiments, the designation is performed in accordance with a random or pseudorandom selection algorithm.

FIG. 3 further illustrates that the entity field 310 (e.g., the first entity field) includes corresponding contents 311, which may be default (e.g., unmodified) contents or non-default (e.g., entity specifying) contents. Similarly, the entity field 320 (e.g., the second entity field) includes corresponding contents 321, which may separately be default (e.g., unmodified) contents or non-default (e.g., entity specifying) contents. Likewise, the entity field 330 (e.g., the third entity field) includes corresponding contents 331, which may separately be default (e.g., unmodified) contents or non-default (e.g., entity specifying) contents. Furthermore, the entity field 390 (e.g., the final entity field) includes corresponding contents 391, which may separately be default (e.g., unmodified) contents or non-default (e.g., entity specifying) contents.

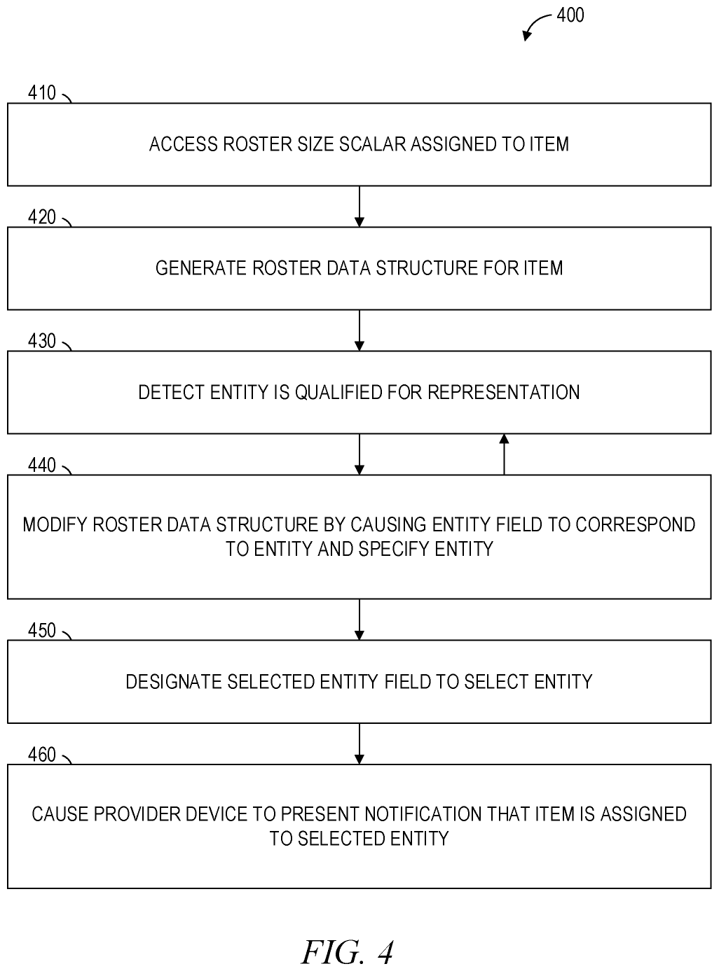

FIGS. 4-7 are flowcharts illustrating operations of the selection machine 110 in performing a method 400 of roster-based selection of an entity (e.g., selection of user 152 from among the users 132, 142, and 152), according to some example embodiments. Operations in the method 400 may be performed by the selection machine 110, using components (e.g., modules) described above with respect to FIG. 2, using one or more processors (e.g., microprocessors or other hardware processors), or using any suitable combination thereof. As shown in FIG. 4, the method 400 includes operations 410, 420, 430, 440, 450, and 460.

In operation 410, the provider interface 210 accesses a roster size scalar. The roster size scalar quantifies entities to be represented in a roster data structure (e.g., the roster data structure 300) to be generated for an item. That is, the roster size scalar sets the number of entities that will be representable by the roster data structure after generation. The roster size scalar may be assigned to an item (e.g., by a provider of the item, such as by the user 122), and the item may accordingly correspond to the roster data structure (e.g., the roster data structure 300) to be generated for the item. The accessing of the roster size scalar may be performed by accessing a memory or database (e.g., the database 115) that stores the roster size scalar, accessing a device (e.g., the device 120 of the user 122) that stores the roster size scalar, receiving the roster size scalar (e.g., from the device 120 of the user 122), or any suitable combination thereof.

In operation 420, the roster manager 220 generates the roster data structure (e.g., the roster data structure 300) that corresponds to the item. As newly generated, the roster data structure includes multiple entity fields (e.g., entity fields 310, 320, 330, and 390) that are quantified by the roster size scalar and whose contents 311, 321, 331, and 391 specify no entities. These entity fields include a final entity field (e.g., the entity field 390), which may additionally function as a readiness indicator for entity selection based on the roster data structure 300.

Operations 430 and 440 may be performed for each entity field among the entity fields (e.g., the entity fields 310, 320, 330, and 390) in the roster data structure (e.g., the roster data structure 300) that corresponds to the item, as generated in operation 420. In operation 430, the roster manager 220 detects that an entity (e.g., one of the users 132, 142, or 152) is qualified for representation in the roster data structure for the item. Details on detecting that the entity has become qualified are provided further below.

In operation 440, the roster manager 220 modifies the roster data structure (e.g., the roster data structure 300) by causing the current entity field (e.g., the entity field 320) to both correspond to the qualified entity (e.g., the user 132) and specify the qualified corresponding entity (e.g., the user 132). This may be performed by causing the current entity field to store an identifier (e.g., name, username, or identification code) of the corresponding entity. By repeated performance of operations 430 and 440, each of the entity fields (e.g., the entity fields 310, 320, 330, and 390) in the roster data structure (e.g., the roster data structure 300) one-by-one becomes modified from containing their respective initial contents to containing respective non-default (e.g., modified and entity specifying) contents. As noted above, when the final entity field (e.g., the entity field 390) that doubles as a readiness indicator is caused to specify its corresponding entity, the entirety of the roster data structure (e.g., the roster data structure 300) is deemed ready for entity selection.

In operation 450, in response to the final entity field (e.g., the entity field 390) specifying its corresponding entity, the entity selector 230 designates one of the entity fields (e.g., one entity field among the entity fields 310, 320, 330, and 390) in the now fully modified roster data structure (e.g., the roster data structure 300) as a selected entity field (e.g., the entity field 330). Since the selected entity field (e.g., the entity field 330) specifies its corresponding entity (e.g., the user 142), the corresponding entity becomes a selected entity. By this process, the entity selector 230 selects an entity (e.g., the user 142) for assignment to the item that corresponds to the roster data structure (e.g., the roster data structure 300).

In operation 460, the provider interface 210 causes a device (e.g., the device 120) that corresponds to a provider (e.g., the user 122) of the item to present (e.g., via a graphical user interface or an audio user interface) a notification that the item is now assigned to the entity (e.g., the user 142) selected in operation 450. In some example embodiments, this notification alone is sufficient to assign the item to the selected entity and cause the provider to provide the item to the selected entity. In other example embodiments, assignment of the item to the selected entity previously occurred as part of operation 450, as described in further detail below.

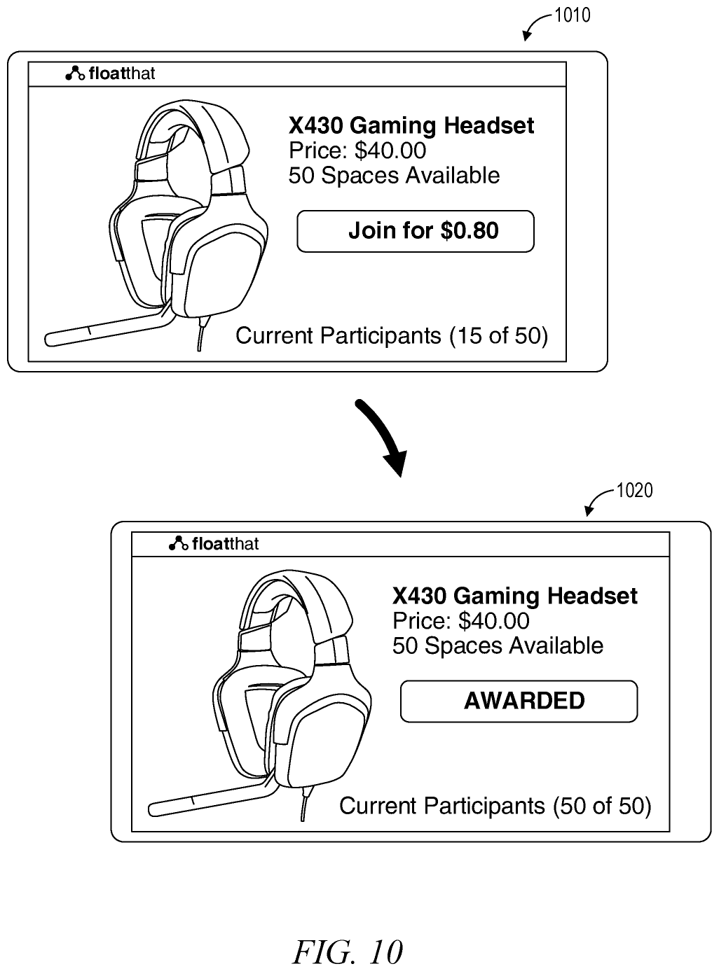

According to various example embodiments, at any point after the generation of the roster data structure in operation 420, the provider interface 210, the entity interface 240, or both, causes one or more devices (e.g., the devices 120 and 130) to present a graphical user interface that indicates a current status of the roster data structure that corresponds the item. This additional operation in the method 400 is described in further detail below with respect to FIG. 10.

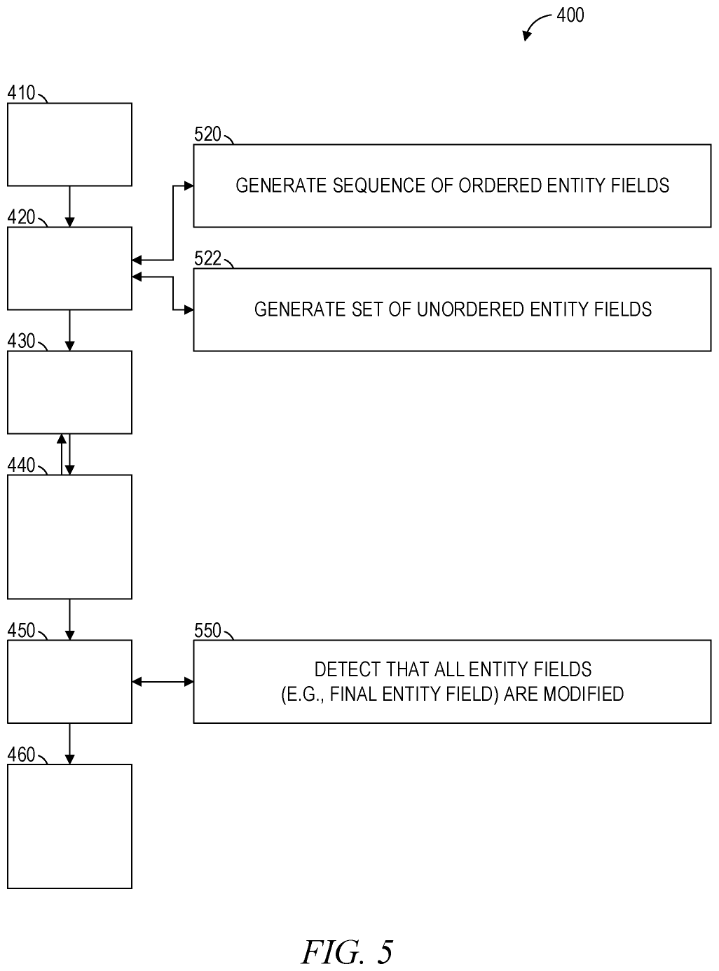

As shown in FIG. 5, in addition to any one or more of the operations previously described, the method 400 may include one or more of operations 520, 522, and 550. One or both of operations 520 and 522 may be performed as part (e.g., a precursor task, a subroutine, or a portion) of operation 420, in which the roster manager 220 generates the roster data structure (e.g., the roster data structure 300) that corresponds to the item.

In operation 520, the roster manager 220 generates the entity fields (e.g., the entity fields 310, 320, 330, and 390) as a sequence of ordered entity fields (e.g., enumerated as first, second, third, etc.). In example embodiments that include operation 520, the roster manager 220 may repeatedly (e.g., cyclically) perform operations 430 and 440 sequentially for each entity field in the sequence, such that operations 430 and 440 are each performed once for any specific entity field (e.g., the entity field 310), until a final entity field (e.g., the entity field 390) becomes modified to contain non-default and entity specifying data (e.g., within the contents 391).

In operation 522, the roster manager 220 generates entity fields (e.g., the entity fields 310, 320, 330, and 390) as a set of unordered entity fields (e.g., without any sequential order or enumeration). In example embodiments that include operation 522, the roster manager 220 may repeatedly (e.g., cyclically) perform operations 430 and 440 for each entity field in the roster data structure (e.g., the roster data structure 300) in any order (e.g., randomly or pseudo-randomly), such that operations 430 and 440 are each performed once for any specific entity field (e.g., the entity field 310), until a final entity field (e.g., the entity field 390) becomes modified to contain non-default and entity specifying data (e.g., within the contents 391).

In hybrid example embodiments in which both operations 520 and 522 are performed, the roster manager 220 may perform operations 430 and 440 for each entity field in the roster data structure (e.g., the roster data structure 300), some entity fields sequentially and some others non-sequentially, until a final entity field (e.g., the entity field 390) is modified to contain non-default and entity specifying contents (e.g., in the contents 391).

FIG. 5 further illustrates that operation 550 may be performed as part (e.g., a precursor task, a subroutine, or a portion) of operation 450, in which the entity selector 230 designates the selected entity field (e.g., the entity field 330, which at this point may specify the user 142). In operation 550, the entity selector 230 detects that all entity fields (e.g., the entity fields 310, 320, 330, and 390) in the roster data structure (e.g., the roster data structure 300) have been modified from their default contents (e.g., in the contents 311, 321, 331, and 391). This may be performed by detecting that a final entity field (e.g., the entity field 390) has been modified to contain non-default and entity specifying contents (e.g., contents 391, which may specify the user 142 at this point). Accordingly, the performance of the remainder of operation 450 may be based on (e.g., responsive to) the detection performed in operation 550.

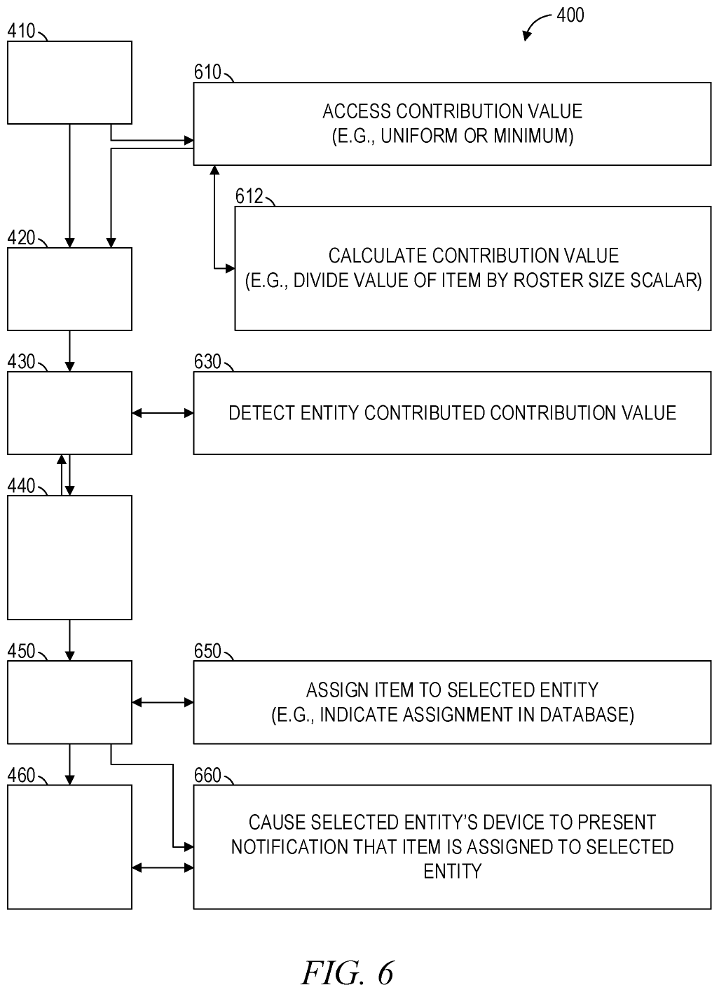

As shown in FIG. 6, in addition to any one or more of the operations previously described, the method 400 may include one or more of operations 610, 612, 630, 650, and 660. In operation 610, the provider interface 210 accesses a contribution value. The contribution value quantifies a contribution to be provided by each interested entity in exchange for qualification to be represented in the roster data structure (e.g., the roster data structure 300) generated for the item. For example, the contribution value accessed may be a uniform contribution value to be contributed by all interested entities for representation in the roster data structure. As another example, the contribution value may be a minimum contribution value to be met or exceeded by all interested entities in exchange for representation in the roster data structure. Accordingly, the contribution value may specify an amount of the medium of exchange (e.g., money, credits, tokens, or points).

FIG. 6 further illustrates that operation 612 may be performed as part of operation 610. In operation 612, the accessing of the contribution value includes calculating or otherwise generating the contribution value. For example, the contribution value (e.g., a uniform contribution value or a minimum contribution value) may be calculated by dividing the total value of the item that corresponds to the roster data structure (e.g., the roster data structure 300) by the roster size scalar accessed in operation 410. To illustrate, if the total value of the item is $1100, and if the roster size scalar is 20, then the contribution value may be calculated to be $50. As another example, contribution value may be calculated based on such a quotient. Since the roster size scalar may be assigned to the item by the provider of the item, the contribution value may thus be indirectly determined by the provider of the item.

In example embodiments that include operation 610, performance of operation 430, in which it is detected that an entity (e.g., the user 132) is qualified to be represented in the roster data structure (e.g., the roster data structure 300), may include performance of operation 630. In operation 630, the roster manager 220 detects that the entity has contributed the contribution value accessed in operation 610, which may have the effect of detecting that the same entity is qualified for representation in the roster data structure. This may be performed by accessing one or more data records in the database 115, where such one or more data records indicate that the entity contributed the contribution value.

FIG. 6 also illustrates that operation 650 may be performed as part of operation 450, in which the entity selector 230 designates the selected entity field (e.g., the entity field 330) so that it specifies the selected entity (e.g., the user 142) to be assigned to the item that corresponds to the roster data structure (e.g., the roster data structure 300). As noted above, in some example embodiments, the notification presented in operation 460 is sufficient to assign the item to the selected entity and cause the provider (e.g., the user 122) to provide the item to the selected entity. In other example embodiments, the assignment of the item to the selected entity is explicitly performed by the entity selector 230 in operation 650. This may be performed by updating the database 115 or one or more data records thereof to indicate the assignment of the item to the selected entity within the database 115.

As additionally shown in FIG. 6, operation 660 may be performed at any point after operation 450 (e.g., with or without performance of operation 460). In operation 660, the entity interface 240 causes a device (e.g., the device 140) that corresponds to the selected entity (e.g., the user 142, now assigned to the item) to present (e.g., via a graphical user interface or an audio user interface) a notification that the item is now assigned to the selected entity (e.g., the user 142).

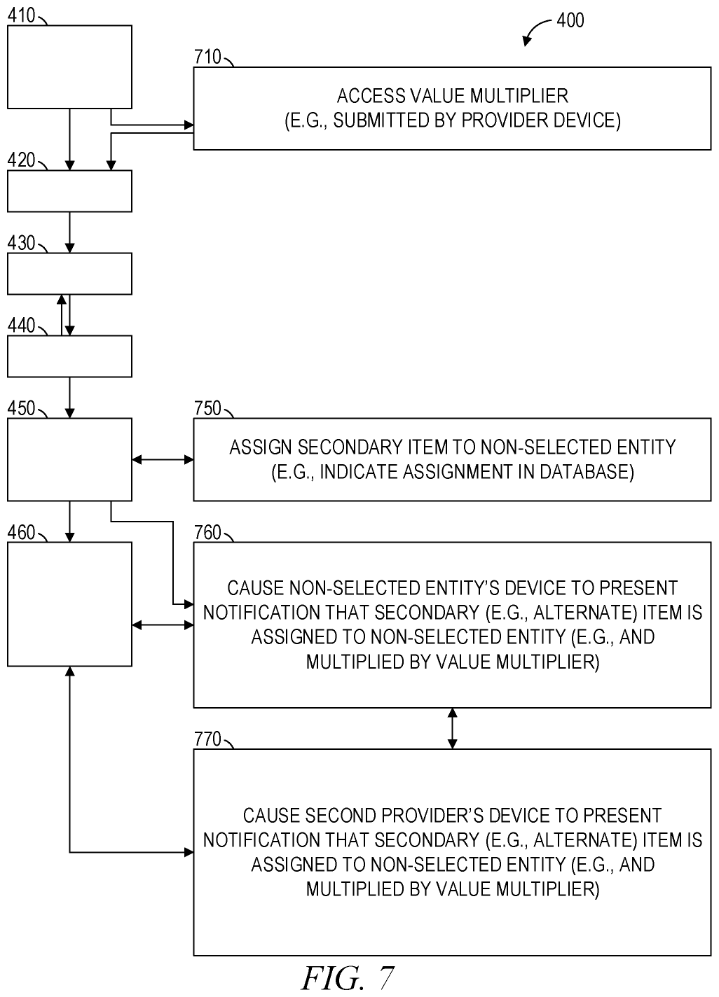

As shown in FIG. 7, in addition to any one or more of the operations previously described, the method 400 may include one or more of operations 710, 750, 760, and 770. In operation 710, the provider interface 210 accesses a value multiplier. The value multiplier is a scalar value submitted by the provider (e.g., the user 122) and indicates that the provider will augment the contribution value contributed by non-selected entities that become represented in the roster data structure (e.g., the roster data structure 300) that corresponds to the item available from the provider. That is, the value multiplier functions as a weighting coefficient to be multiplied to the contribution value, and the product of the contribution value and the value multiplier will be assigned to each of the non-selected entities represented in the roster data structure. The accessing of the value multiplier may be performed by accessing a memory or database (e.g., the database 115) that stores the value multiplier, accessing a device (e.g., the device 120 of the user 122) that stores the value multiplier, receiving the value multiplier (e.g., from the device 120 of the user 122), or any suitable combination thereof.

FIG. 7 also illustrates that operation 750 may be performed as part of operation 450, in which the entity selector 230 designates the selected entity field (e.g., the entity field 330), thus specifying the selected entity (e.g., the user 142) to be assigned to the item that corresponds to the roster data structure (e.g., the roster data structure 300). In some example embodiments, the item that corresponds to the roster data structure (e.g., the roster data structure 300) is a primary item (e.g., a main item) that becomes assigned to the selected entity (e.g., the user 142), and one or more instances of the secondary item (e.g., an alternate item) become assigned to one or more non-selected entities (e.g., the users 132 and 152). According to some example embodiments, the primary item for which the roster data structure was generated is available from a primary provider (e.g., the user 122), and the instances of the secondary item are available from the same primary provider. According to various example embodiments, though, the instances of the secondary item are available from a different, secondary provider.

In operation 750, the entity selector 230 assigns a secondary item to a non-selected entity (e.g., the user 152), and this may be performed by updating the database 115 or one or more data records thereof to indicate the assignment of the secondary item to the non-selected entity within the database 115. Operation 750 may be repeated for each of the non-selected entities (e.g., the user 132) represented in the roster data structure (e.g., the roster data structure 300), until each of the non-selected entities has been assigned to the corresponding instance of the secondary item. According to some example embodiments, each instance of the secondary item is an amount of a medium of exchange, and this amount may be equal to (e.g., match) the contribution value contributed by the non-selected entity for representation in the roster data structure for the primary item.

As additionally shown in FIG. 7, operation 760 may be performed at any point after operation 450 (e.g., with or without performance of operation 460). In operation 760, the entity interface 240 causes a device (e.g., the device 150) that corresponds to a non-selected entity (e.g., the user 152, now assigned to a corresponding instance of the secondary item) to present (e.g., via a graphical user interface or an audio user interface) a notification that the instance of the secondary item is now assigned to the non-selected entity (e.g., the user 152). Operation 760 may be repeated for each of the non-selected entities (e.g., the user 132) assigned to an instance of the secondary item.

In example embodiments where the primary item is available from a primary provider (e.g., the user 122) and where the instances of the secondary item are available from a secondary provider (e.g., a provider different from the user 122), operation 770 may be performed at any point after operation 450 (e.g., with or without performance of either or both of operations 460 and 760). In operation 770, the entity interface 240 causes a device (e.g., the device 150) that corresponds to a non-selected entity (e.g., the user 152, now assigned to an instance of the secondary item) to present (e.g., via a graphical user interface or an audio user interface) a notification that the corresponding instance of the secondary item is now assigned to the non-selected entity (e.g., the user 152).

In example embodiments that include operation 710, in which the provider interface 210 accesses the value multiplier, the notification presented to a non-selected entity (e.g., the user 152) may indicate that the assigned instance of the secondary item (e.g., an amount of a medium of exchange) is multiplied or it is to be multiplied by the value multiplier. In some cases, the notification may further indicate that the provider (e.g., primary or secondary) of the instance of the secondary item has augmented or will augment the secondary item (e.g., by multiplying the secondary item by the value multiplier).

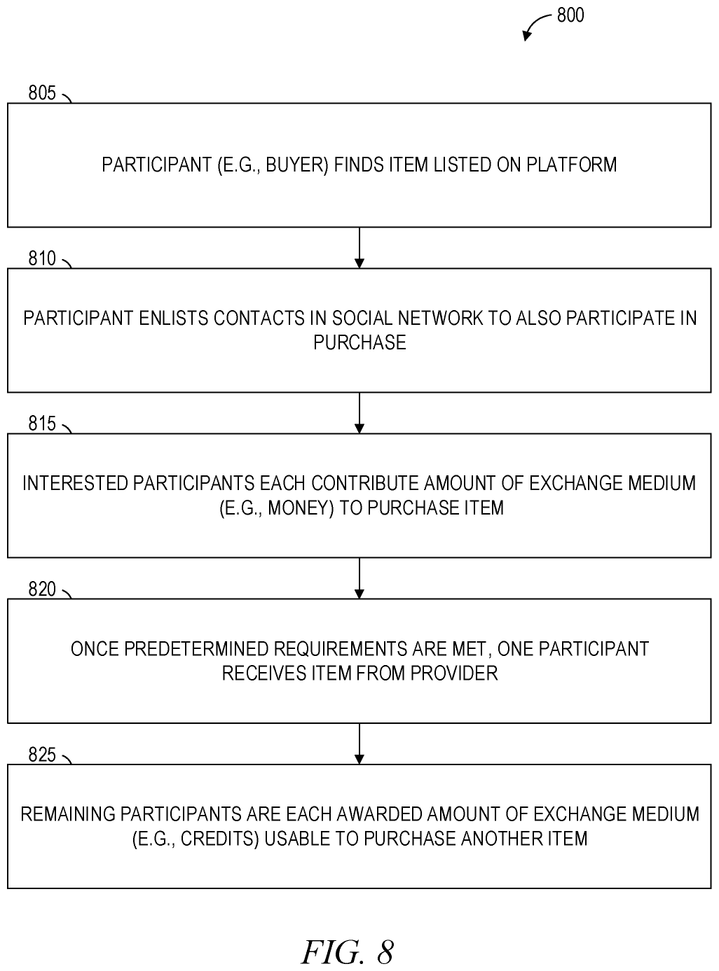

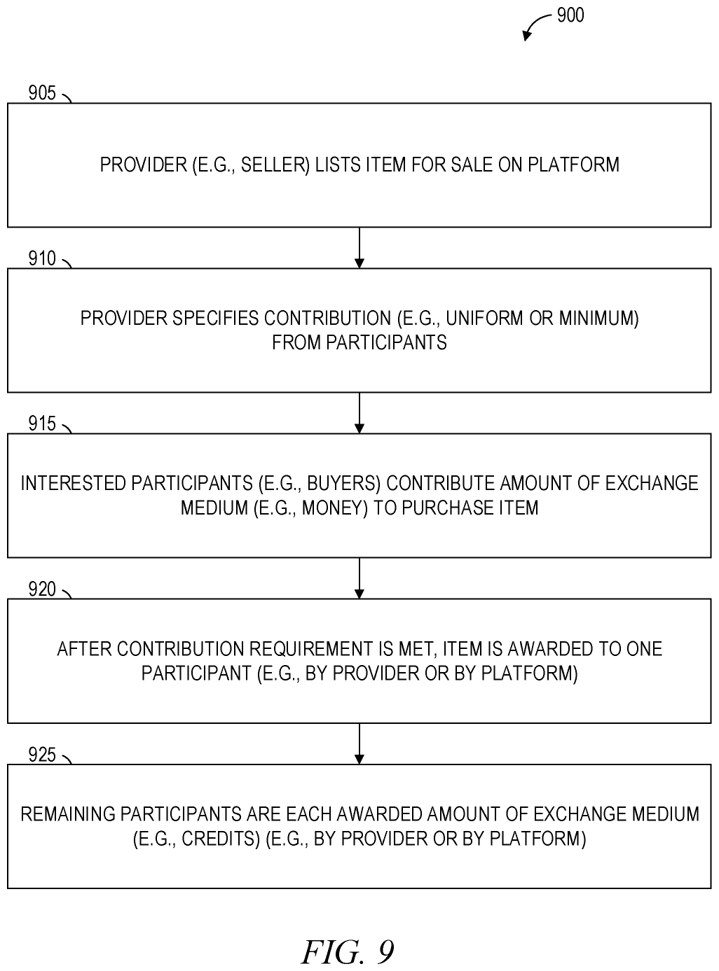

FIGS. 8 and 9 are flowcharts illustrating example user-level experiences 800 and 900 potentially provided or otherwise facilitated by the selection machine 110 in performing certain example embodiments of method 400 of roster-based entity selection, according to those certain example embodiments. In such certain example embodiments, the network-based system 105 provides users (e.g., the users 122, 132, 142, and 152) with a virtual environment that facilities buying or selling of items, such as goods or services. Typically, a user (e.g., the user 132) can access the network-based system 105 via a corresponding device (e.g., the device 130), browse through various descriptions of available items, and select one or more items for which the user would like to participate in a group purchasing experience.

As shown in FIG. 8, at stage 805, the user (e.g., the user 132) may find and select an item that he or she wants to purchase. Optionally, at stage 810, the user may then enlist one or more other participants (e.g., via one or more social networks, such as a social media network) to engage in the group purchasing experience. For example, the user may utilize social media, email contact lists, and the like, to recruit or otherwise encourage other users (e.g., the user 142) to participate in the group purchase. The network-based system 105 may accordingly link to or otherwise communicate with one or more of various third-party platforms, such as social media websites, email contact lists, and the like, to obtain contact information and engage those other users, such as by sending an electronic message to each of these other users. The user (e.g., the user 132) may also request that the network-based system 105 assist in engaging other users (e.g., unknown to the user 132) to participate in the group purchase. For example, the network-based system 105 may store a contact list, such that the user (e.g., the user 132) can engage each of the contacts on the contact list directly though the network-based system 105 via electronic messaging.

At stage 815, for each group purchase, each participating user (e.g., the users 132, 142, and 152, plus one or more other users) may contribute an amount of money towards the group purchase of the item. The description of each group purchase may indicate one or more of various requirements to be met before the item will be assigned (e.g., awarded), such as a predetermined number of participants (e.g., contributors) or total contribution amount (e.g., a total aggregate of all contribution values contributed by entities represented in the roster data structure 300). The total contribution amount may be based on or otherwise correspond to a retail price (e.g., actual or estimated) of the item. For example, a seller (e.g., the user 122) may offer a television, with a retail value of $1100, for sale. The seller may require that twenty participants (e.g., contributors) each contribute $50, or the seller may require that the total contributions by any number of participants reaches $1100, with all participants contributing equal amounts.

At stage 820, after the participating and contributing users (e.g., participants or contributors) have contributed their respective contribution values toward the group purchase of the item, and the predetermined number of users or total contribution amount has been reached, one of the users (e.g., the user 142) will be assigned to the item. The user assigned to the item may be referred to as the winner of the item. In example embodiments where the selection of the winner is random or pseudorandom, each user's odds of being awarded the item depends on the total number of participating users in the group purchasing experience.

At stage 825, the remaining participating and contributing users who were not awarded the item may be awarded instances of a secondary (e.g., alternate) item, such as credits, which may be stored or otherwise recorded in the database 115 of the network-based system 105. Each non-winning user (e.g., the user 132) may utilize his or her credits to participate in one or more different group purchasing experiences at one or more later times.

As shown in FIG. 9, at stage 905, a provider (e.g., the user 122) of the item may be a seller of the item and may offer the item (e.g., along with one or more additional items) for sale via the network-based system 105. At stage 910, the network-based system 105 may allow the provider to indicate one or more of various requirements for awarding the item, such as a predetermined number of participating and contributing users, a total contribution amount required to award the item, or both. The network-based system 105 may utilize various algorithms to directly market the group purchase experience to certain selected users (e.g., the user 132), and the selection of such users may be based on their buying history or other user information.

At stage 915, those certain selected users may then engage one or more other users (e.g., the user 142) to participate in the group purchasing experience through their respective contact lists, social media, and the like, as described above. At stage 920, once the provider specified requirements have been met, the provider (e.g., the user 122) awards the item to one of the participating and contributing users (e.g., the user 142). At stage 925, the remaining participating and contributing users (e.g., the user 132) who did not receive the item may be awarded instances of a secondary (e.g., alternate) item, such as credits, as described above. Each non-winning user (e.g., the user 132) may utilize his or her credits to participate in another group purchasing experience later.

In some example forms of the user experiences illustrated in FIGS. 8 and 9, the network-based system 105 may allow users who have been awarded credits to apply their respective credits proportionally to a future group purchasing experience for the same item or for a different item. For example, if a user (e.g., the user 132) contributed $20 towards a group purchase of an item with a retail price of $1100, but is not awarded the item, then the user may apply that $20 credit toward a future group purchase of the same item that is worth $1100. However, the network-based system 105 may notify the user that he or she can apply the credit to a different item that is $500, but if applied thereto, the credit would be worth only $10.

In certain example forms of the user experiences illustrated in FIGS. 8 and 9, the network-based system 105 may allow a group of users (e.g., the users 132, 142, and 152) to contribute to a group purchase of an item for the purpose of gifting the item to an entity, such as an individual or an organization, which may be called a gift recipient. In such a case, each participating and contributing user (e.g., the users 132, 142, and 152) may contribute any arbitrary contribution value (e.g., any amount of money) toward the group purchase. Once the total contribution amount has reached a predetermined amount (e.g., set by the provider of the item), the item will be awarded to the gift recipient (e.g., by the provider of the item).

In various example forms of the user experiences illustrated in FIGS. 8 and 9, users (e.g., the users 132, 142, and 152) may also earn points that can be used to participate in one or more group purchasing experiences. In such cases, a user (e.g., the user 132) is not required to spend or apply any monetary contribution value to a group purchase to participate. Instead, the user may earn points based on their social outreach, social media presence, or both. For example, the user may earn points by posting a group purchase (e.g., as a provider) on the network-based system 105, soliciting other users to participate in a group purchase, discussing a particular item on a social media website, receiving “likes,” “shares,” or comments on a social media post about the item, or any suitable combination thereof. In some situations, a predetermined number of points may be equivalent to a predetermined monetary value (e.g., via an equivalency rate or other exchange rate). For example, the user may receive 1 point per 1100 “likes” on a social media posting, and 1 point may be equivalent to $1 (e.g., when used to contribute to a group purchasing experience via the network-based system 105). Once the user has accumulated some points, the user may apply those accumulated points to one or more group purchases according to an equivalency rate, rules related to contributions for the particular group purchase, or both. The winner in that group purchasing experience may be selected according to any one or more of the methods described above.

FIG. 10 is a diagram illustrating example screenshots 1010 and 1020 of a graphical user interface during and after roster-based entity selection, according to some example embodiments. The graphical user interface may be presented (e.g., display) by a device (e.g., the device 130, 140, or 150) of an entity (e.g., the user 132, 142, or 152). As noted above, this may be performed as an additional operation the method 400 discussed above.

As shown in FIG. 10, the first screenshot 1010 depicts and references an item (e.g., a gaming headset) that is available from a provider (e.g., the user 122). In this scenario, the roster-based entity selection process is in progress, meaning that the roster data structure (e.g., the roster data structure 300) for this item has been generated (e.g., via operation 420 discussed above) but the item has not yet been assigned (e.g., via operation 450 or 460 discussed above). As a specific example, the illustrated first screenshot 1010 indicates that the roster data structure has a roster size of fifty (50) entity fields (e.g., as defined by its corresponding roster size scalar), and fifteen (15) entity fields (e.g., similar to the entity fields 310, 320, and 330) have been modified to indicate non-default contents that specify entities. In other words, up to fifty (50) entities can be specified by this roster data structure, and there are fifteen (15) currently specified by this roster data structure.

From viewing the first screenshot 1010, it can be inferred (e.g., by the user 132, 142, or 152) that there are forty-five (45) entity fields (e.g., similar to the entity fields 310, 320, and 330) that still have default contents remaining within the roster data structure. Moreover, a control element (e.g., button) labeled “Join for $0.80” invites a viewing entity to qualify for representation in the roster data structure (e.g., by contributing $0.80) and thereby become specified by one of the remaining unmodified entity fields. Accordingly, the first screenshot 1010 of the graphical user interface conveys the current status of the roster data structure for this item to one or more entities (e.g., the user 132, 142, or 152) during the roster-based entity selection process.

As shown in FIG. 10, the second screenshot 1020 also depicts and references the item (e.g., the gaming headset) available from the provider (e.g., the user 122). However, in this scenario, the roster-based entity selection process has completed, meaning that the roster data structure (e.g., the roster data structure 300) for this item has no more entity fields with default contents. That is, at this point in this specific example, all fifty (50) entity fields in the roster data structure have been modified to indicate non-default contents, and each specifies a corresponding entity. Moreover, since the final entity field (e.g., similar to the entity field 390) now specifies a corresponding entity and has triggered the assignment of the item (e.g., via operation 450 or 460 discussed above), the second screenshot 1020 accordingly indicates by the word “AWARDED” that is no longer possible for more entities to qualify for representation in the roster data structure for this item, and that the item has been assigned to one of the entities that did qualify for representation in the roster data structure. Thus, the second screenshot 1020 of the graphical user interface conveys the final status of the roster data structure for this item to one or more entities (e.g., the user 132, 142, or 152) after completion of the roster-based entity selection process.

According to various example embodiments, one or more of the methodologies described herein may facilitate automated selection of an entity by a machine, based on (e.g., by generating and using) a roster data structure (e.g., the roster data structure 300). Moreover, one or more of the methodologies described herein may facilitate automated assignment of one or more items to one or more entities by the machine. Hence, one or more of the methodologies described herein may facilitate improved disposition of items by the machine, as well as improved generation and communication of notifications thereof by the machine, compared to capabilities of pre-existing systems and methods.

When these effects are considered in aggregate, one or more of the methodologies described herein may obviate a need for certain efforts or resources that otherwise would be involved in roster-based entity selection. Efforts expended by a user in performing entity selection of any kind may be reduced by use of (e.g., reliance upon) a special-purpose machine that implements one or more of the methodologies described herein. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

FIG. 11 is a block diagram illustrating components of a machine 1100 (e.g., the selection machine 110), according to some example embodiments, able to read instructions 1124 from a machine-readable medium 1122 (e.g., a non-transitory machine-readable medium, a machine-readable storage medium, a computer-readable storage medium, or any suitable combination thereof) and perform any one or more of the methodologies discussed herein, in whole or in part. Specifically, FIG. 11 shows the machine 1100 in the example form of a computer system (e.g., a computer) within which the instructions 1124 (e.g., software, a program, an application, an applet, an app, or other executable code) for causing the machine 1100 to perform any one or more of the methodologies discussed herein may be executed, in whole or in part.

In alternative embodiments, the machine 1100 operates as a standalone device or may be communicatively coupled (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any suitable combination thereof), a main memory 1104, and a static memory 1106, which are configured to communicate with each other via a bus 1108. The processor 1102 contains solid-state digital microcircuits (e.g., electronic, optical, or both) that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein. In some example embodiments, the processor 1102 is a multicore CPU (e.g., a dual-core CPU, a quad-core CPU, an 8-core CPU, or a 128-core CPU) within which each of multiple cores behaves as a separate processor that is able to perform any one or more of the methodologies discussed herein, in whole or in part. Although the beneficial effects described herein may be provided by the machine 1100 with at least the processor 1102, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 1100 may further include a graphics display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a pointer input device 1114 (e.g., a mouse, a touchpad, a touchscreen, a trackball, a joystick, a stylus, a motion sensor, an eye tracking device, a data glove, or other pointing instrument), a data storage 1116, an audio generation device 1118 (e.g., a sound card, an amplifier, a speaker, a headphone jack, or any suitable combination thereof), and a network interface device 1120.

The data storage 1116 (e.g., a data storage device) includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the static memory 1106, within the processor 1102 (e.g., within the processor's cache memory), or any suitable combination thereof, before or during execution thereof by the machine 1100. Accordingly, the main memory 1104, the static memory 1106, and the processor 1102 may be considered machine-readable media (e.g., tangible and non-transitory machine-readable media). The instructions 1124 may be transmitted or received over the network 190 via the network interface device 1120. For example, the network interface device 1120 may communicate the instructions 1124 using any one or more transfer protocols (e.g., hypertext transfer protocol (HTTP)).

In some example embodiments, the machine 1100 may be a portable computing device (e.g., a smart phone, a tablet computer, or a wearable device), and may have one or more additional input components 1130 (e.g., sensors or gauges). Examples of such input components 1130 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a temperature input component (e.g., a thermometer), and a gas detection component (e.g., a gas sensor). Input data gathered by any one or more of these input components 1130 may be accessible and available for use by any of the modules described herein (e.g., with suitable privacy notifications and protections, such as opt-in consent or opt-out consent, implemented in accordance with user preference, applicable regulations, or any suitable combination thereof).

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of carrying (e.g., storing or communicating) the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof.

A “non-transitory” machine-readable medium, as used herein, specifically excludes propagating signals per se. According to various example embodiments, the instructions 1124 for execution by the machine 1100 can be communicated via a carrier medium (e.g., a machine-readable carrier medium). Examples of such a carrier medium include a non-transient carrier medium (e.g., a non-transitory machine-readable storage medium, such as a solid-state memory that is physically movable from one place to another place) and a transient carrier medium (e.g., a carrier wave or other propagating signal that communicates the instructions 1124).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated statements describe various examples of methods, machine-readable media, and systems (e.g., machines, devices, or other apparatus) discussed herein.

A first example provides a method comprising:

accessing, by one or more processors of a machine, a roster size scalar assigned to an item by a provider of the item, the roster size scalar quantifying entities to be represented in a roster data structure that corresponds to the item;
generating, by one or more processors of the machine, the roster data structure that corresponds to the item, the roster data structure including entity fields that are quantified by the roster size scalar and that specify no entities, the entity fields including a final entity field;
for each entity field among the entity fields, and by one or more processors of the machine: detecting that an entity is qualified for representation in the roster data structure that corresponds to the item, and modifying the roster data structure by causing the entity field to correspond to the entity and specify the entity;
in response to the final entity field being caused to specify its corresponding entity, and by one or more processors of the machine, designating a selected entity field among the entity fields, the selected entity field specifying a corresponding entity selected for assignment to the item; and
causing, by one or more processors of the machine, a device of the provider of the item to present a notification that the item is assigned to the selected entity specified by the selected entity field in the modified roster data structure.

A second example provides a method according to the first example, wherein:

the generating of the roster data structure generates a sequence of ordered entity fields that include the final entity field; and
the designating of the selected entity field is in response to modification of all entity fields in the sequence of ordered entity fields.

A third example provides a method according to the first example, wherein:

the generating of the roster data structure generates a set of unordered entity fields that include the final entity field; and
the designating of the selected entity field is in response to modification of all entity fields in the set of unordered entity fields.

A fourth example provides a method according to any of the first through third examples, wherein:

the generating of the roster data structure includes generating the entity fields with default content that specifies no entities; and
the designating of the selected entity field is in response to the final entity field being caused to include non-default content.

A fifth example provides a method according to any of the first through fourth examples, further comprising:

accessing a uniform contribution value that corresponds to the roster data structure; and wherein:
for each entity field among the entity fields, the detecting that the corresponding entity is qualified for representation in the roster data structure includes detecting that the entity contributed the uniform contribution value for representation in the roster data structure.

A sixth example provides a method according to the fifth example, wherein:

the accessing of the uniform contribution value includes calculating the uniform contribution value by dividing a total value of the item by the roster size scalar assigned to the item by the provider.

A seventh example provides a method according to any of the first through sixth examples, wherein:

the device of the provider is a first device, and the notification is a first notification; and
the method further comprises:
causing a second device of the selected entity to present a second notification that the item is assigned to the selected entity.

An eighth example provides a method according to any of the first through seventh examples, wherein:

the device of the provider is a first device, and the notification is a first notification;
the item is a primary item among a plurality of assignable items; and
the method further comprises:
causing a second (or third) device of a non-selected entity among entities represented in the modified roster data structure to present a second (or third) notification that a secondary item among the plurality of assignable items is assigned to the non-selected entity.

A ninth example provides a method according to the eighth example, wherein:

each entity represented in the modified roster data structure contributed a uniform contribution value for representation in the roster data structure;
the secondary item assigned to the non-selected entity includes an amount of a medium of exchange, the amount matching the uniform contribution value; and
the second notification presented by the second device of the non-selected entity indicates the amount assigned to the non-selected entity.

A tenth example provides a method according to the eighth example, wherein:

each entity represented in the modified roster data structure contributed a uniform contribution value for representation in the roster data structure;
the secondary item assigned to the non-selected entity includes an amount of a medium of exchange, the amount matching the uniform contribution value;
the method further comprises:
accessing a value multiplier submitted by the first device of the provider; and wherein:
the second notification presented by the second device of the non-selected entity indicates that the amount assigned to the non-selected entity is multiplied by the value multiplier.

An eleventh example provides a method according to the tenth example, wherein:

the second notification indicates that the provider of the item multiplied the amount by the value multiplier submitted by the provider.

A twelfth example provides a method according to any of the first through seventh examples, wherein:

the device of the provider is a first device of a first provider, and the notification is a first notification;
the item is a primary item available from the first provider; and the method further comprises:
causing a second device of a second provider to present a second notification that a secondary item available from the second provider is assigned to a non-selected entity among entities represented in the roster data structure.

A thirteenth example provides a method according to the twelfth example, wherein:

each entity represented in the modified roster data structure contributed a uniform contribution value for representation in the roster data structure;
the secondary item assigned to the non-selected entity includes an amount of a medium of exchange, the amount matching the uniform contribution value; and
the method further comprises:
causing a third device of the non-selected entity to present a third notification that indicates the amount assigned to the non-selected entity.

A fourteenth example provides a method according to the twelfth example, wherein:

each entity represented in the modified roster data structure contributed a uniform contribution value for representation in the roster data structure;
the secondary item assigned to the non-selected entity includes an amount of a medium of exchange, the amount matching the uniform contribution value; and
the method further comprises:
accessing a value multiplier submitted by the second device of the second provider; and
causing a third device of the non-selected entity to present a third notification that the amount assigned to the non-selected entity is multiplied by the value multiplier.

The fifteenth example provides a method according to the fourteenth example, wherein:

the third notification indicates that the second provider multiplied the amount by the value multiplier submitted by the second provider.

A sixteenth example provides a method according to any of the first through fifteenth examples, wherein:

the item includes at least one of a physical good, a digital good, a service, an authorization, or an amount of a medium of exchange.

A seventeenth example provides a machine-readable medium (e.g., a non-transitory machine-readable storage medium) comprising instructions that, when executed by one or more processors of a machine, cause the machine to perform operations comprising:

accessing a roster size scalar assigned to an item by a provider of the item, the roster size scalar quantifying entities to be represented in a roster data structure that corresponds to the item;
generating the roster data structure that corresponds to the item, the roster data structure including entity fields that are quantified by the roster size scalar and that specify no entities, the entity fields including a final entity field;
for each entity field among the entity fields: detecting that an entity is qualified for representation in the roster data structure that corresponds to the item, and modifying the roster data structure by causing the entity field to correspond to the entity and specify the entity;
in response to the final entity field being caused to specify its corresponding entity, designating a selected entity field among the entity fields, the selected entity field specifying a corresponding entity selected for assignment to the item; and
causing a device of the provider of the item to present a notification that the item is assigned to the selected entity specified by the selected entity field in the modified roster data structure.

An eighteenth example provides a machine-readable medium according to the seventeenth example, wherein:

the generating of the roster data structure generates a sequence of ordered entity fields that include the final entity field; and
the designating of the selected entity field is in response to modification of all entity fields in the sequence of ordered entity fields.

A nineteenth example provides a system (e.g., a computer system or other computing machine) comprising:

one or more processors; and
a memory storing instructions that, when executed by at least one processor among the one or more processors, cause the system to perform operations comprising:
accessing a roster size scalar assigned to an item by a provider of the item, the roster size scalar quantifying entities to be represented in a roster data structure that corresponds to the item;
generating the roster data structure that corresponds to the item, the roster data structure including entity fields that are quantified by the roster size scalar and that specify no entities, the entity fields including a final entity field;
for each entity field among the entity fields: detecting that an entity is qualified for representation in the roster data structure that corresponds to the item, and modifying the roster data structure by causing the entity field to correspond to the entity and specify the entity;
in response to the final entity field being caused to specify its corresponding entity, designating a selected entity field among the entity fields, the selected entity field specifying a corresponding entity selected for assignment to the item; and
causing a device of the provider of the item to present a notification that the item is assigned to the selected entity specified by the selected entity field in the modified roster data structure.

A twentieth example provides a system according to the nineteenth example, wherein:

the generating of the roster data structure includes generating the entity fields with default content that specifies no entities; and
the designating of the selected entity field is in response to the final entity field being caused to include non-default content.

A twenty-first example provides a carrier medium carrying machine-readable instructions for controlling a machine to carry out the operations (e.g., method operations) performed in any one of the previously described examples.

1. A method comprising:
accessing, by one or more processors of a machine, a roster size scalar assigned to an item by a provider of the item, the roster size scalar quantifying entities to be represented in a roster data structure that corresponds to the item;
generating, by one or more processors of the machine, the roster data structure that corresponds to the item, the roster data structure including entity fields that are quantified by the roster size scalar and that specify no entities, the entity fields including a final entity field;
for each entity field among the entity fields, and by one or more processors of the machine:
detecting that an entity is qualified for representation in the roster data structure that corresponds to the item; and
modifying the roster data structure by causing the entity field to correspond to the entity and specify the entity;
in response to the final entity field being caused to specify its corresponding entity, and by one or more processors of the machine, designating a selected entity field among the entity fields, the selected entity field specifying a corresponding entity selected for assignment to the item; and
causing, by one or more processors of the machine, a device of the provider of the item to present a notification that the item is assigned to the selected entity specified by the selected entity field in the modified roster data structure.

2. The method of claim 1, wherein:
the generating of the roster data structure generates a sequence of ordered entity fields that include the final entity field; and
the designating of the selected entity field is in response to modification of all entity fields in the sequence of ordered entity fields.

3. The method of claim 1, wherein:
the generating of the roster data structure generates a set of unordered entity fields that include the final entity field; and
the designating of the selected entity field is in response to modification of all entity fields in the set of unordered entity fields.

4. The method of claim 1, wherein:
the generating of the roster data structure includes generating the entity fields with default content that specifies no entities; and
the designating of the selected entity field is in response to the final entity field being caused to include non-default content.

5. The method of claim 1, further comprising:
accessing a uniform contribution value that corresponds to the roster data structure; and wherein:
for each entity field among the entity fields, the detecting that the corresponding entity is qualified for representation in the roster data structure includes detecting that the entity contributed the uniform contribution value for representation in the roster data structure.

6. The method of claim 5, wherein:
the accessing of the uniform contribution value includes calculating the uniform contribution value by dividing a total value of the item by the roster size scalar assigned to the item by the provider.

7. The method of claim 1, wherein:
the device of the provider is a first device, and the notification is a first notification; and
the method further comprises:
causing a second device of the selected entity to present a second notification that the item is assigned to the selected entity.

8. The method of claim 1, wherein:
the device of the provider is a first device, and the notification is a first notification;
the item is a primary item among a plurality of assignable items; and
the method further comprises:
causing a second device of a non-selected entity among entities represented in the modified roster data structure to present a second notification that a secondary item among the plurality of assignable items is assigned to the non-selected entity.

9. The method of claim 8, wherein:
each entity represented in the modified roster data structure contributed a uniform contribution value for representation in the roster data structure;
the secondary item assigned to the non-selected entity includes an amount of a medium of exchange, the amount matching the uniform contribution value; and
the second notification presented by the second device of the non-selected entity indicates the amount assigned to the non-selected entity.

10. The method of claim 8, wherein:
each entity represented in the modified roster data structure contributed a uniform contribution value for representation in the roster data structure;
the secondary item assigned to the non-selected entity includes an amount of a medium of exchange, the amount matching the uniform contribution value;
the method further comprises:
accessing a value multiplier submitted by the first device of the provider; and wherein:
the second notification presented by the second device of the non-selected entity indicates that the amount assigned to the non-selected entity is multiplied by the value multiplier.

11. The method of claim 10, wherein:
the second notification indicates that the provider of the item multiplied the amount by the value multiplier submitted by the provider.

12. The method of claim 1, wherein:
the device of the provider is a first device of a first provider, and the notification is a first notification;
the item is a primary item available from the first provider; and
the method further comprises:
causing a second device of a second provider to present a second notification that a secondary item available from the second provider is assigned to a non-selected entity among entities represented in the roster data structure.

13. The method of claim 12, wherein:
each entity represented in the modified roster data structure contributed a uniform contribution value for representation in the roster data structure;
the secondary item assigned to the non-selected entity includes an amount of a medium of exchange, the amount matching the uniform contribution value; and
the method further comprises:
causing a third device of the non-selected entity to present a third notification that indicates the amount assigned to the non-selected entity.

14. The method of claim 12, wherein:
each entity represented in the modified roster data structure contributed a uniform contribution value for representation in the roster data structure;
the secondary item assigned to the non-selected entity includes an amount of a medium of exchange, the amount matching the uniform contribution value; and
the method further comprises:
accessing a value multiplier submitted by the second device of the second provider; and
causing a third device of the non-selected entity to present a third notification that the amount assigned to the non-selected entity is multiplied by the value multiplier.

15. The method of claim 14, wherein:
the third notification indicates that the second provider multiplied the amount by the value multiplier submitted by the second provider.

16. The method of claim 1, wherein:
the item includes at least one of a physical good, a digital good, a service, an authorization, or an amount of a medium of exchange.

17. A machine-readable medium comprising instructions that, when executed by one or more processors of a machine, cause the machine to perform operations comprising:
accessing a roster size scalar assigned to an item by a provider of the item, the roster size scalar quantifying entities to be represented in a roster data structure that corresponds to the item;
generating the roster data structure that corresponds to the item, the roster data structure including entity fields that are quantified by the roster size scalar and that specify no entities, the entity fields including a final entity field;
for each entity field among the entity fields:
detecting that an entity is qualified for representation in the roster data structure that corresponds to the item; and
modifying the roster data structure by causing the entity field to correspond to the entity and specify the entity;
in response to the final entity field being caused to specify its corresponding entity, designating a selected entity field among the entity fields, the selected entity field specifying a corresponding entity selected for assignment to the item; and
causing a device of the provider of the item to present a notification that the item is assigned to the selected entity specified by the selected entity field in the modified roster data structure.

18. The machine-readable medium of claim 17, wherein:
the generating of the roster data structure generates a sequence of ordered entity fields that include the final entity field; and
the designating of the selected entity field is in response to modification of all entity fields in the sequence of ordered entity fields.

19. A system comprising:
one or more processors; and
a memory storing instructions that, when executed by at least one processor among the one or more processors, cause the system to perform operations comprising:
accessing a roster size scalar assigned to an item by a provider of the item, the roster size scalar quantifying entities to be represented in a roster data structure that corresponds to the item;
generating the roster data structure that corresponds to the item, the roster data structure including entity fields that are quantified by the roster size scalar and that specify no entities, the entity fields including a final entity field;
for each entity field among the entity fields:
detecting that an entity is qualified for representation in the roster data structure that corresponds to the item; and
modifying the roster data structure by causing the entity field to correspond to the entity and specify the entity;
in response to the final entity field being caused to specify its corresponding entity, designating a selected entity field among the entity fields, the selected entity field specifying a corresponding entity selected for assignment to the item; and
causing a device of the provider of the item to present a notification that the item is assigned to the selected entity specified by the selected entity field in the modified roster data structure.

20. The system of claim 19, wherein:
the generating of the roster data structure includes generating the entity fields with default content that specifies no entities; and
the designating of the selected entity field is in response to the final entity field being caused to include non-default content.
